(19) United States
(12) Patent Application Publication
(10) Pub. No.: US 2008/0074984 A1
(43) Pub. Date: Mar. 27, 2008

(54) Architecture for a Memory Device

(75) Inventor: Donald Edward Adams, Pleasanton, CA (US)

Correspondence Address: FLIESLER MEYER LLP, 650 CALIFORNIA STREET, 14TH FLOOR, SAN FRANCISCO, CA, 94108, US

(73) Assignee: NANOCHIP, INC., Fremont, CA (US)

(21) Appl. No.: 11/859,667

(22) Filed: Sep. 21, 2007

Related U.S. Application Data
(60) Provisional application No. 60/846,605, filed on Sep. 21, 2006.

(51) Int. Cl. G11B 9/00

(52) U.S. Cl. 369/126

(57) ABSTRACT

A memory device for a probe storage system comprises a media die including a frame and a media platform movably coupled with the frame, a tip die connected with the frame such that the tip die is generally parallel to the media platform, the tip die including a plurality of tip groups, wherein a tip group includes a number of tips, a set of electrical traces connected between the media platform and the frame, a number of electrical traces of the set of electrical traces corresponding to the number of tips. The set of electrical traces is selectably associable with one of the tip groups so that the tips of the associated tip group are in electrical communication with the media die.

### CLAIM OF PRIORITY

This application claims benefit to the following U.S. Provisional Patent Application:

U.S. Provisional Patent Application No. 60/846,605 entitled ARCHITECTURE FOR A MEMORY DEVICE, by Donald Adams, filed Sep. 21, 2006, Attorney Docket No. NANO-01045US0.

### CROSS-REFERENCE TO RELATED PATENT APPLICATIONS

This application incorporates by reference all of the following co-pending applications:

U.S. patent application Ser. No. 11/553,421, entitled “Bonded Chip Assembly with a Micro-Mover for Microelectromechanical Systems,” Attorney Docket No. NANO-01041US1, filed Oct. 26, 2006.

U.S. patent application Ser. No. 11/553,435, entitled “Memory Stage for a Probe Storage Device,” Attorney Docket No. NANO-01043US1, filed Oct. 26, 2006.

U.S. patent application Ser. No. 11/553,408, entitled “Cantilever with Control of Vertical and Lateral Position of Contact Probe Tip,” Attorney Docket No. NANO-01044US1, filed Oct. 26, 2006.

U.S. patent application Ser. No. 11/553,449 entitled “Cantilever with Control of Vertical and Lateral Position of Contact Probe Tip,” Attorney Docket No. NANO-01044US2, filed Oct. 26, 2006.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This invention relates to high density data storage using molecular memory integrated circuits.

### BACKGROUND

Software developers continue to develop steadily more data intensive products, such as ever-more sophisticated, and graphic intensive applications and operating systems (OS). Each generation of application or OS always seems to earn the derisive label in computing circles of being “a memory hog.” Higher capacity data storage, both volatile and non-volatile, has been in persistent demand for storing code for such applications. Add to this need for capacity, the confluence of personal computing and consumer electronics in the form of personal MP3 players, such as the iPod, personal digital assistants (PDAs), sophisticated mobile phones, and laptop computers, which has placed a premium on compactness and reliability.

Nearly every personal computer and server in use today contains one or more hard disk drives for permanently storing frequently accessed data. Every mainframe and supercomputer is connected to hundreds of hard disk drives. Consumer electronic goods ranging from camcorders to TiVo® use hard disk drives. While hard disk drives store large amounts of data, they consume a great deal of power, require long access times, and require “spin-up” time on power-up. FLASH memory is a more readily accessible form of data storage and a solid-state solution to the lag time and high power consumption problems inherent in hard disk drives. Like hard disk drives, FLASH memory can store data in a non-volatile fashion, but the cost per megabyte is dramatically higher than the cost per megabyte of an equivalent amount of space on a hard disk drive, and is therefore sparingly used.

Phase change media are used in the data storage industry as an alternative to traditional recording devices such as magnetic recorders (tape recorders and hard disk drives) and solid state transistors (EEPROM and FLASH). CD-RW data storage discs and recording drives use phase change technology to enable write-erase capability on a compact disc-style media format. CD-RWs take advantage of changes in optical properties (e.g., reflectivity) when phase change material is heated to induce a phase change from a crystalline state to an amorphous state. A “bit” is read when the phase change material subsequently passes under a laser, the reflection of which is dependent on the optical properties of the material. Unfortunately, current technology is limited by the wavelength of the laser, and does not enable the very high densities required for use in today's high capacity portable electronics and tomorrow's next generation technology such as systems-on-a-chip and micro-electric mechanical systems (MEMS). Consequently, there is a need for solutions which permit higher density data storage.

### BRIEF DESCRIPTION OF THE DRAWINGS

Further details of the present invention are explained with the help of the attached drawings in which:

FIG. 1A is a schematic representation of an embodiment of a system for communicatively connecting a plurality of tips with control electronics in accordance with the present invention; FIG. 1B is a portion of the schematic of FIG. 1A illustrating a tip in electrical communication with the control electronics.

FIG. 2 is a schematic representation of an embodiment of a memory device for use in storing information in accordance with the present invention employing the schematic representation of FIG. 1A.

FIG. 3 is a plan view of an embodiment of a media platform having capacitive sensors.

FIG. 4 is an exploded view of an embodiment of an assembly for use in probe storage devices in accordance with the present invention.

FIG. 5 is a schematic representation of an embodiment of a system for storing information comprising a plurality of the memory devices of FIG. 2.

### DETAILED DESCRIPTION

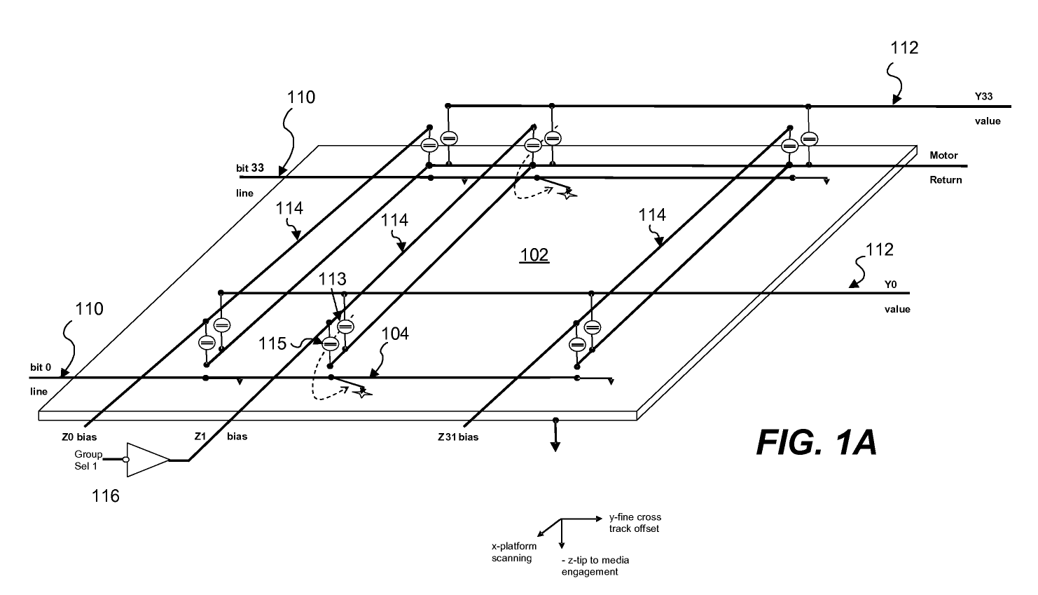

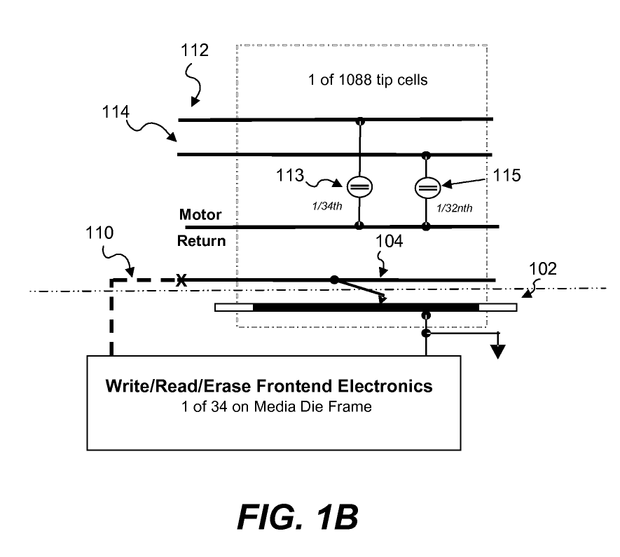

FIG. 1A is a schematic representation of an embodiment of a portion of a memory device in accordance with the present invention comprising a plurality of tips 104 arranged in groups and actuatable to contact a media 102 of a media die for forming or reading indicia in the media 102 and/or on the surface of the media 102. The tips 104 can be arranged in groups to reduce a number of “active” tips 104 from which signals are sent and received, thereby minifying a number of interconnects (also referred to herein as electrical traces) between a tip die and control circuitry of the memory device. Common interconnects, which can include for example bit lines 110 and planar offset interconnects 112, etc., can be electrically connectable with any and/or all of the groups. To reduce a total number of interconnects required, a selected group 116 is electrically connected with common interconnects, while unselected groups are disconnected from common interconnects. The selected group 116 can be electrically connected by way of z-actuators 115 that urge tips 104 of the group so that the tips 104 contact the media 102. Group actuation interconnects 114 associated with each group can carry signals to the z-actuators 115 to actuate tips 104 of the group.

The number of tips 104 deployable on a tip platform associated with a tip die, and the number of groups 116 into which the number of tips 104 are arranged, can determine a number of interconnects between the tip die and the media 102. For example, if 1,088 deployable tips 104 extend from the platform, and the 1,088 tips 104 are arranged in thirty-two groups 116 having substantially the same number of respective deployable tips 104, it is desirable that thirty-four bit lines 110 be employed to receive and provide signals to the tips 104. Use of common interconnects enables management of a large potential number of signals and thereby increases flexibility in design. For example, as shown in FIGS. 1A and 1B, a tip 104 from each group can employ a common planar offset interconnect 112 to allow fine position correction for the tip 104 of the selected group 116 by planar actuation of a cantilever associated with the tip 104. In some embodiments, electrostatic actuators 113 can be incorporated to enable fine positioning of the tips 104 across a desired number of tracks, for example +/−3 tracks. U.S. patent application Ser. No. 11/553,408, entitled “Cantilever with Control of Vertical and Lateral Position of a Contact Probe Tip,” (Attorney Docket: NANO-01044US1) and U.S. patent application Ser. No. 11/553,449, entitled “Cantilever with Control of Vertical and Lateral Position of a Contact Probe Tip,” (Attorney Docket: NANO-01044US2) incorporated herein by reference, discloses an electrostatic actuator for fine positioning of a tip across multiple tracks.

Use of fine position correction mechanisms (such as electrostatic actuators) for multiple tips can enable a method of self-servo writing on continuous media. For example, in one embodiment of a method of self-servo writing, adjacent tracks can be written to a media having an approximately uniform pitch separating the tracks. To achieve the approximately uniform pitch the tips can be separated into two groups during self servo writing. A first track can be written to the media using both groups of tips, the media and the tips being moved relative to one another as guided by a coarse position sensor. Half of the written lines can then be tracked by one of the two groups of tips using the coarse position sensor and the fine positioning error from the group of tips. The other of the two groups of tips can be offset using the fine position correction mechanisms, for example one track pitch in distance. A new track can be written by the other of the two groups of tips while tracking the originally written track with the one of the two groups of tips. The tracking and writing groups of tips can then be alternated to complete the writing of the adjacent track. The process can be repeated as desired to self-servo write the continuous media. In still other embodiments, some other combination of track following and track writing can be employed using coarse position sensors and fine position correction mechanisms to self-servo write a continuous media. One of ordinary skill in the art, in light of the present teachings, will appreciate that myriad different variations that can be applied to self-servo write a media using a combination of the coarse positioning sensors and fine positioning mechanisms. The present invention is not intended to be limited to self-servo writing by dividing tips into two groups, but rather the present invention is meant to encompass all such schemes that can take advantage of coarse position sensors and fine position mechanisms for enabling fine position offsets between tips.

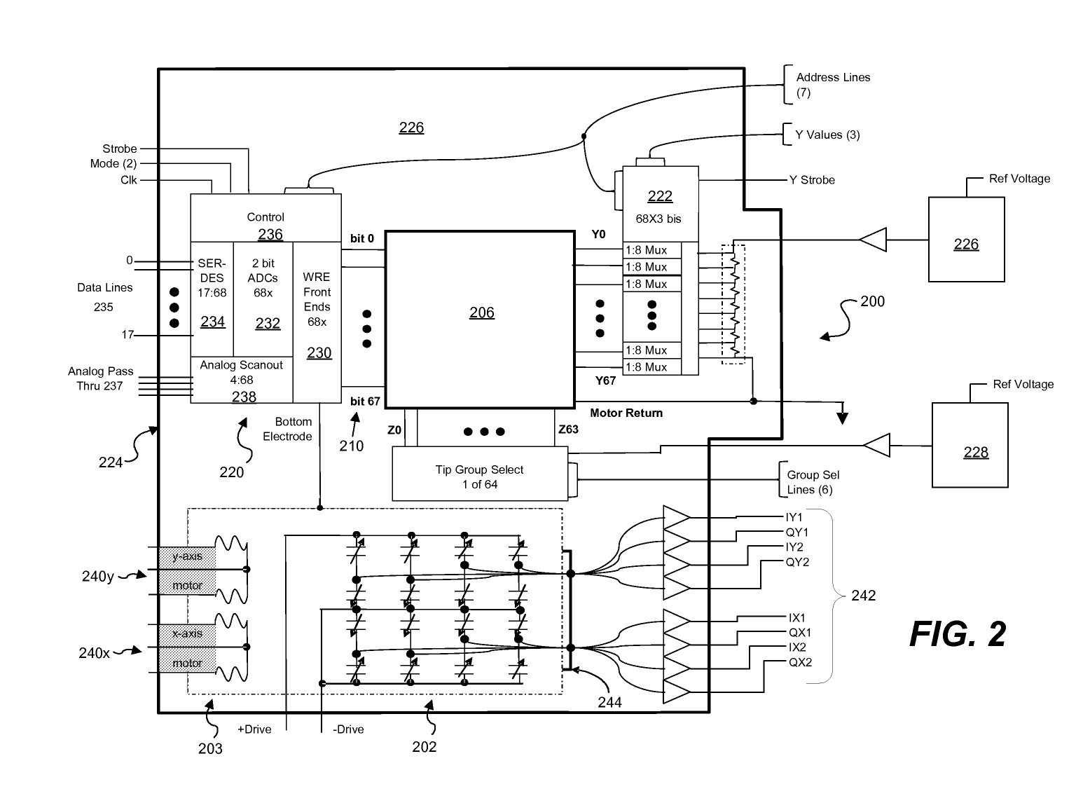

Referring to FIG. 2, an embodiment of a memory device 200 in accordance with the present invention is shown. In the embodiment, a tip die 206 supports 4,352 deployable tips arranged in sixty-four groups. The tip die 206 employs sixty-eight active bit lines (four bit lines being used for error correcting code (ECC)) to electrically communicate with an active group of sixty-eight tips. The memory device controller 220 and associated circuitry can be built onto the media frame 226 (i.e., the stationary portion) of the media die 224. Alternatively, the memory device controller 220 and associated circuitry can be built external to the media die 224, for example on a circuit board or on the tip die 206.

A planar offset register bank 222 can selectably provide planar offset information through the common planar offset interconnect 212 based on a selected group. The planar offset register bank 222 can store planar offset information for each tip (e.g., 4,352 values for the tip die 206 described above) while a number of common planar offset interconnects 212 required are as few as the number of tips of the selected group. The planar offset information can be provided through a slave digital-to-analog converter (DAC)(not shown). The slave DAC includes 68×3 bits of local memory, and the planar offset information is multiplexed out from the slave DAC to the tips of the selected group. A master DAC 226 provides an input for the slave DAC.

As schematically illustrated, a tip die 206 supporting 4,352 tips can electrically communicate with the memory device controller 220 using 201 interconnects (including a motor return interconnect). The common interconnects are reducible to 133 where planar offsets are not employed, or where planar offsets are multiplexed using a bit line, for example. The tip die 206 can be fixedly associated with the media frame 226 to avoid a need for flexible interconnects communicating the tip die 206 with the memory device controller 220. However, where a movable tip platform is employed, minifying interconnects can be important for reducing the complexity of integrating the media device.

As shown, group select provides an actuation signal that allows tips within the group to actuate toward the media 202, contacting the media 202 to form circuits with the common interconnects. In an embodiment, the actuation mechanism employed can be an electrostatic actuator so that the actuation signal removes an electrostatic force between electrodes, for example as described in U.S. patent application Ser. No. 11/553,408, entitled “Cantilever with Control of Vertical and Lateral Position of a Contact Probe Tip,” (Attorney Docket: NANO-01044US1) and U.S. patent application Ser. No. 11/553,449 entitled “Cantilever with Control of Vertical and Lateral Position of a Contact Probe Tip,” (Attorney Docket: NANO-01044US2). In other embodiments, the electrostatic actuator can be employed to urge the tip toward the media when an actuation signal is applied. In still further embodiments, the actuation mechanism can be some other mechanism, such as a thermal bimorph, or an electromagnetic actuator. Group select circuitry can be formed on the media die 224 to reduce a number of pins for providing signals to the tip die 206. An actuation force DAC 228 arranged outside of the media device 200 can allow the actuation force to be generally adjusted, providing external actuation control by way of a one pin connection, although in other embodiments, pins can be provided for actuation control external of the media device 200 for each of the active tips.

The memory device controller 220 comprises write/read front-end electronics 230 electrically connectable with the tip die 206 by way of bit lines 210. In the embodiment shown, there can be sixty-eight bit lines 210 for sixty-eight tips. The memory device controller 220 further comprises analog-to-digital converters (ADC) 232 for preliminary decision-making and a serializer/deserializer (SERDES) 234 for converting data from/to a serial data stream and a parallel data stream. Binary data is multiplexed to 17 data lines 235 by way of the SERDES. Still further, the memory device controller 220 includes a control 236 for multiplexing and an analog pass-through scan-out 238 where 4 of 68 of the bit lines 237 are passed out for the primary purpose of scanning-out fine position information embedded in data for off-set and thermal drift control of the tips. The scanned-out information can be used to control the values updated for updating the planar offset register bank 222 to keep tips centered as temperature changes and the tips are subjected to thermal drift effects. Final ECC can be employed to correct incorrect determinations of the memory device controller 220.

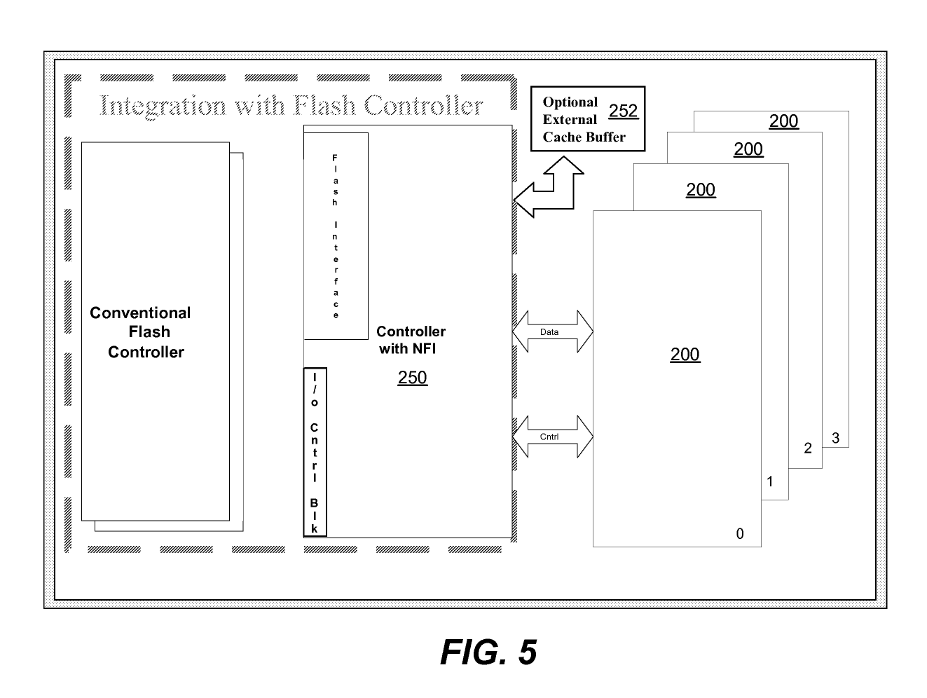

The analog pass-through scan-out 238 described above allows detection of a servo pattern embedded on the media 202 and arranged within data and read by four tips at a given time (in an embodiment). Thus, in this example the analog pass-through scan-out 238 scans out information from four tips at a time cycling through the sixty-eight tips. The position is modulated through a feedback control loop (see FIG. 5) that updates planar offset data for the corresponding tip for which scan-out data is obtained. The master offset DAC 226 can be adjusted and the individual planar offset value can be adjusted for the corresponding tip. In an embodiment, the feedback control loop can be included in a controller chip (by way of a digital signal processor (DSP)).

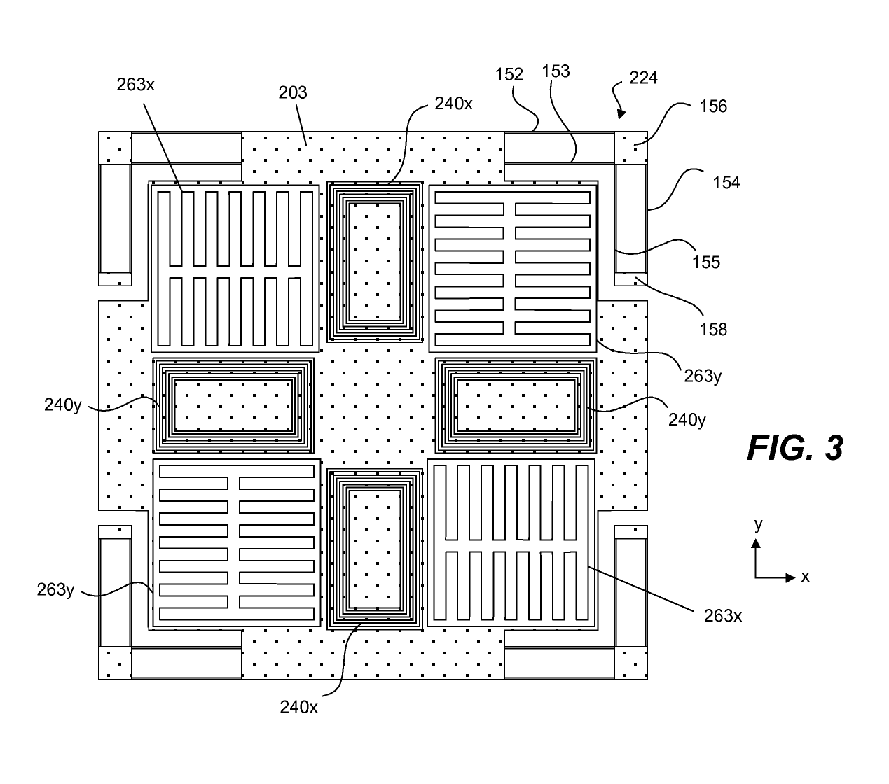

The media 202 for storing indicia is associated with a movable portion of the media die 224 referred herein as a media platform 203. The media platform 203 is electrically connected with the memory device controller 220, forming a circuit allowing indicia to be formed and/or read from the media 102. Referring to FIG. 3, the media platform 203 is movable in a Cartesian plane by way of electromagnetic motors 240 comprising operatively connected wires (also referred to herein as coils, although the wires need not consist of closed loops) placed in a magnetic field such that motion of the media platform 203 can be achieved when current is applied to the wires. The corresponding tip platform can be fixed in position. The media platform 203 can be urged in a Cartesian plane by taking advantage of Lorentz forces generated from current flowing in the coils 240 when a magnetic field perpendicular to the Cartesian plane is applied across the coil current path. The coils 240 can be arranged at ends of two perpendicular axes and can be formed such that the media 202 is disposed between the coils 240 and the tip platform (e.g. fixedly connected with a back of the media platform 203, wherein the back is a surface of the media platform 203 opposite a surface contactable by the tip platform). In a preferred embodiment, the coils 240 can be arranged symmetrically about a center of the media platform, with one pair of coils 240x generating force for lateral (X) motion and the other pair of coils 240y generating force for transverse (Y) motion. Utilization of the surface of the media platform for data storage need not be affected by the coil layout because the coils can be positioned so that the media for storing data is disposed between the coils and the tip platform, rather than co-planar with the coils. In other embodiments the coils can be formed co-planar with the surface of media platform. In such embodiments, a portion of the surface of the media platform will be dedicated to the coils, reducing utilization for data storage.

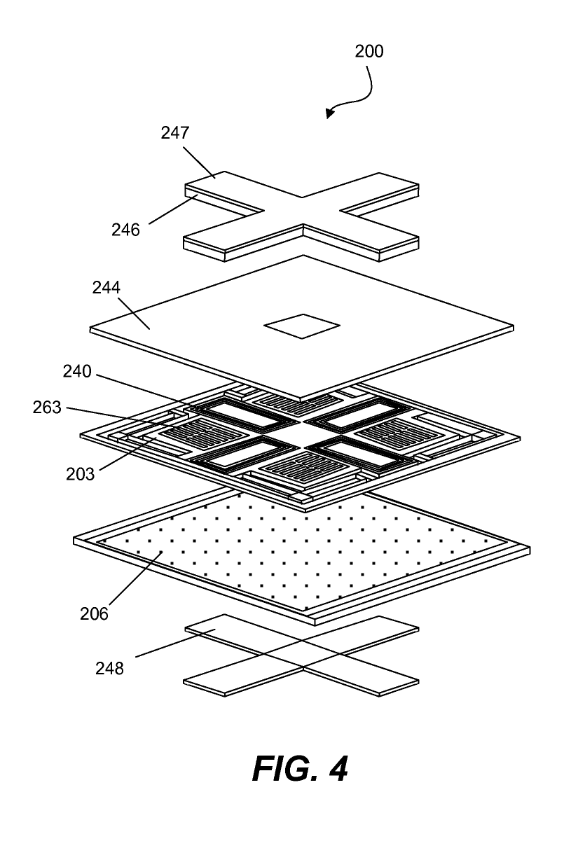

Referring to FIG. 4, a magnetic field is generated outside of the media platform 203 by a permanent magnet 246 arranged so that the permanent magnet 246 maps the two perpendicular axes, the ends of which include the coils. The permanent magnet can be fixedly connected with a rigid structure such as a steel plate 247 to form a magnet structure. The magnet structure can be associated with a cap wafer 244. A second steel plate 248 can be arranged so that the tip die 206, media platform 203, and coils 240 are disposed between the magnet structure and the second steel plate 248. The magnetic flux is contained within the gap between the magnet structure and the second steel plate. In alternative embodiments, a pair of magnets can be employed such that the platforms and coils are disposed between dual magnets, thereby increasing the flux density in the gap between the magnets. The force generated from the coil is proportional to the flux density, thus the required current and power to move the media platform can be reduced at the expense of a larger package thickness. There is a possibility that a write current applied to one or more tips could disturb the media platform due to undesirable Lorentz force. However, for probe storage devices having media devices comprising phase change material, polarity dependent material, ferroelectric material or other material requiring similar or smaller write currents to induce changes in material properties, media platform movement due to write currents is sufficiently small as to be within track following tolerance. In some embodiments, it can be desired that electrical trace lay-out be configured to generally negate the current applied to the tip, thereby minifying the influence of write current.

Coarse servo control of the media platform 203 can be achieved through the use of capacitive sensors. The media platform 203 can rely on a pair of capacitive sensors arranged at four locations using each pair of capacitive sensors for extracting a ratiometric signal independent of Z-displacement of the media platform 203. Two electrodes (not shown) are formed on one or both of the top and bottom caps 244. A third electrode 263 is integrally formed or fixedly connected with the media platform 203 to form a differential pair. Two capacitors are formed between the first electrode and third electrode 263, and between the second electrode and the third electrode 263. A ratio of capacitances can be sensitive to horizontal displacement of the media platform 203 with respect to the stationary portion 226 in the plane of the figure (X-displacement) and this ratio can be insensitive to Y and Z displacements of the media platform 203 with respect to the stationary portion. Thus, for a pair of capacitive sensors adapted to measure motion along an axis, at least two readings can be obtained from which can be extracted displacement along the axis and rotation about a center of the media platform 203. Four electrodes 263 are integrally formed or fixedly connected with the media platform 203. As shown in FIG. 3, the electrodes 263 are arranged in quarters of the media platform 203. Two electrodes 263x are designed to provide signals proportional to X displacement of the media platform 203, and two other electrodes 263y are designed to provide signals proportional to Y displacement of the media platform 203. Preferably, each electrode 263 on the media platform 203 faces a differential pair of electrodes on one or both of the caps (not shown). Processing signals from all capacitive sensors allows extracting three displacement and three rotational components of the motion of the media platform 203 with respect to one or both caps.

In alternative embodiments, the media platform can have more or fewer pairs of capacitive sensors. In particular, pairs of capacitive sensors sensitive to the same type of motion (lateral (X), transverse (Y), X-Y skew or others) can be implemented in such a way that output signal of the first sensor is close to zero level and the output signal of the second sensor is close to its full scale output when the media platform is in equilibrium position. When the media platform is in an extreme position then an output signal of the first sensor is close to its full scale output and the output signal of the second sensor is close to zero.

Electrical connections to the media platform may require use of bridges. It is desirable to minify the use of bridges; therefore, it can be advantageous to employ position sensors requiring the smallest number of electrical connections between the media platform and the stationary portion. Capacitive sensing allows electrodes located on the media platform to be connected with the substrate, which can act as a common electrode. The substrate potential can be set to ground or to the high potential. Connecting capacitor plates to the substrate creates parasitic capacitors between the substrate and the stationary portions. In order to reduce the parasitic capacitance the media platform can be micro-machined between the fingers of the electrodes. Shallow cavities in the areas between the fingers can reduce parasitic capacitance. Wires bridge across the media platform to the media frame, allowing signals to be electrically communicated out side of the memory device. The capacitive sensors allow control of media platform skew, and are driven differentially. A stator portion of the capacitive sensors is associated with a cap wafer. Sense amplified signals are provided from the stators to an interface controller (not shown).

In alternative embodiments, Hall-effect sensors sensitive to magnetic field can be used to determine the position of the media platform. Hall-effect sensors measure position based on changes of the mobility of carriers in the presence of magnetic field. Hall-effect sensors can be employed in the media platform, for example, in the form of magneto-resistors or magneto-transistors. Hall-effect sensors can be arranged in areas of the media platform where a component of the magnetic field has its largest gradient. Areas with large gradients of magnetic field exist in the middle of the coils where the magnetic field changes polarity. Displacement of the media platform causes changes in the magnetic field created by stationary magnets and can be detected by the Hall-effect sensors.

In still further embodiments, thermal position sensors can be used to determine the position of the media platform. Myriad different types of thermal sensors can be employed. For example, a thermal position sensor containing a heater and a differential pair of temperature sensors can be employed. In one embodiment, a stationary heater (e.g. a resistive heater) can be formed on one of the cap wafers, and two temperature sensors can be connected with the media platform and located symmetrically with respect to the heater so that in a neutral position a differential signal from the pair of temperature sensors is small. When the media platform is urged away from a neutral position the distance between the stationary heater and one of the temperature sensors increases. Correspondingly, the distance between the heater and the other of the temperature sensors decreases. The temperature difference resulting from this movement causes an electrical signal proportional to the displacement of the media platform.

Similarly to capacitive position sensors at least four magnetic or temperature sensors can be employed in order to measure displacement of the media platform within the Cartesian plane and the angle of rotation of the media plate within the Cartesian plane. At least two additional sensors can be employed in order to measure rotation of the media platform in X-Z and Y-Z planes.

A number of pins communicating signals from the memory device to an interface controller can be reduced to approximately sixty pins. The number of pins required can vary substantially depending on the amount and type of information processed by an interface controller, and an amount and type of information processed by the memory device controller. Referring to FIG. 5, one or more memory devices 200 can be multiplexed to an interface controller 250. As shown, four memory devices 200 are multiplexed back to the interface controller 250. In an embodiment, the interface controller 250 can perform such functions as higher level tip selection and multiplexing, circuit control, servo component control, servo modulation, and DSP for x-axis scan control, y-axis seek, y-axis position, etc. The interface controller 250 can include a data path and buffer controllers, and therefore can manage data to and from the memory devices, as well as electromagnetic position information using local buffers (external 252 or integrated). The ECC will operate on the data as necessary, and pass data to the interface controller and out according to its specifications.

The foregoing description of the present invention has been presented for purposes of illustration and description. It is not intended to be exhaustive or to limit the invention to the precise forms disclosed. Many modifications and variations will be apparent to practitioners skilled in this art. The embodiments were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

1. A memory device for a probe storage system comprising:
a media die including a frame and a media platform movably coupled with the frame;
a tip die connected with the frame such that the tip die is generally parallel to the media platform, the tip die including a plurality of tip groups, wherein a tip group includes a number of tips;
a set of electrical traces connected between the media platform and the frame, a number of electrical traces of the set of electrical traces corresponding to the number of tips;
wherein the set of electrical traces is selectably associable with one of the tip groups so that the tips of the associated tip group are in electrical communication with the media die.

2. The memory device of claim 1, wherein:
each tip is connected with the tip die by way of a cantilever; and
the set of electrical traces is selectably associable with the one of the tip groups by urging cantilevers associated with the tip group so that the number of tips of the tip group contacts the media platform.

3. The memory device of claim 2, wherein the cantilevers are urged by electrostatic force.

4. The memory device of claim 1 further comprising:
a permanent magnet connected with the tip die;
two or more wires connected with the media platform to provide a current that interacts with a magnetic field of the permanent magnet;
wherein the media platform is movable relative to the frame by applying a current to the two or more wires.

5. The memory device of claim 1, wherein the tips are movable relative to one another in a plane of the media platform.

6. The memory device of claim 5, further comprising:
a memory device controller; and
a planar offset electrical trace connected between the controller and a cantilever associated with one tip from each of the plurality of tip groups; and
wherein a tip is movable in a plane of the media platform by urging a corresponding cantilever; and
wherein the corresponding cantilever is urged by providing a signal to the planar offset electrical trace.

7. The memory device of claim 4 further comprising:
a cap wafer connected with the frame so that the media platform is arranged between the cap wafer and the tip die;
a capacitive sensor including a first electrode and a second electrode associated with the cap wafer, a third electrode associated with the media platform;
wherein movement of the media platform relative to the cap wafer is determinable based on a signal from the capacitive sensor.

8. A method of reading information from a probe storage memory device including a media and a plurality of tips communicably connectable with the media and assigned to a plurality of groups of tips comprising:
providing a signal to an electrical trace associated with a group of tips from the plurality of tips;
urging the group of tips toward the media so that the group of tips is in communication with the media;
communicating a signal to a portion of the media by providing a signal to an electrical trace associated with a tip from each of the plurality of groups of tips so that the signal is communicated to the tip of the group of tips in communication with the media; and
determining a bit state of the portion of the media die.

9. The memory device of claim 8 wherein a tip is connected with a tip platform by a cantilever pivotable at a fulcrum; and
wherein urging the group of tips toward the media includes applying an electrostatic force to an end of each of the respective cantilevers so that the cantilever pivots at the fulcrum and urges the corresponding tip toward the media.

10. The memory device of claim 8, wherein communicating a signal to a portion of the media includes providing one of a current and a voltage to the tip.

11. The memory device of claim 9, wherein determining a bit state of the portion of the media die includes measuring an electrical resisitivity of the portion of the media die.

12. The memory device of claim 8, further comprising:
determining an adjustment in a position of a tip relative to a data track on the media;
providing a signal to an electrical trace associated with one tip from each of the plurality of tip groups;
urging the one tip from each of the plurality of tip groups so that the position of the tip relative to the data track is changed.

13. The memory device of claim 12 wherein a tip is connected with a tip platform by a cantilever; and
wherein urging the one tip from each of the plurality of tip groups includes applying an electrostatic force to the respective cantilevers so that the cantilever pivots and urges the corresponding tip relative to the data track.

14. The memory device of claim 13, wherein communicating a signal to a portion of the media includes providing one of a current and a voltage to the tip.

15. A memory device for a probe storage system comprising:
a memory device controller;
a media die including a frame and a media platform movably coupled with the frame;
a tip die connected with the frame such that the tip die is generally parallel to the media platform, the tip die including a plurality of tip groups, wherein a tip group includes a number of tips connected with the tip die by a cantilever;
a set of electrical traces connected between the media platform and the memory device controller, a number of electrical traces of the set of electrical traces corresponding to the number of tips;
wherein the set of electrical traces is selectably associable with one of the tip groups so that the tips of the associated tip group are in electrical communication with the media die.

16. The memory device of claim 15, wherein the set of electrical traces is selectably associable with the one of the tip groups by urging cantilevers associated with the tip group so that the number of tips of the tip group contacts the media platform.

17. The memory device of claim 16, wherein the cantilevers are urged by electrostatic force.

18. The memory device of claim 15 further comprising:
an electromagnetic motor connected between the movable platform and the tip die.

19. The memory device of claim 18, further comprising:
a planar offset electrical trace connected between the memory device controller and a cantilever associated with one tip from each of the plurality of tip groups; and
wherein a tip is movable in a plane of the media platform by urging a corresponding cantilever; and
wherein the corresponding cantilever is urged by providing a signal to the planar offset electrical trace.
